(19) United States
(12) Patent Application Publication
(10) Pub. No.: US 2010/0030865 A1
(43) Pub. Date: Feb. 4, 2010

(54) Method for Prioritizing E-mail Messages Based on the Status of Existing E-mail Messages

(75) Inventors: Hui Jiang, Austin, TX (US); Indran Naick, Cedar Park, TX (US); Jeffrey Kenneth Wilson, Austin, TX (US); Rohit R. Sahasrabudhe, Austin, TX (US)

Correspondence Address: KING & SPALDING, 1180 PEACHTREE ST., ATLANTA, GA, 30309, US

(73) Assignee: International Business Machines Corporation, Armonk, NY (US)

(21) Appl. No.: 12/184,153

(22) Filed: Jul. 31, 2008

(51) Int. Cl. G06F 15/16

(52) U.S. Cl. 709/207

(57) ABSTRACT

Prioritizing e-mail messages based on the status of existing e-mail messages. Specifically, the invention provides methods and systems for prioritizing e-mail messages based on the number of e-mail messages from e-mail senders that have been opened versus the number of e-mail messages from e-mail senders that have not been opened.

### FIELD OF THE INVENTION

The present disclosure relates generally to the field of e-mail communication, and more particularly to methods and systems for prioritizing e-mail messages in an e-mail client application based on the status of existing e-mail messages.

### BACKGROUND

Electronic mail (e-mail) messages are messages that are sent or received electronically over a computer network. E-mail messages are typically stored on an e-mail server and accessed by an e-mail client application. E-mail client applications include user interfaces that can reside on a conventional computer or other device such as mobile telephone. For example, an e-mail message can be generated by a person at one conventional computer and sent to another person who may access the e-mail message by way of a mobile phone, provided that both the conventional computer and the mobile phone have an e-mail client application and have access to an e-mail server.

Communication by way of e-mail messages has become popular, especially in business settings. This popularity has caused a lot of e-mail users to get an excessive amount of e-mail messages that are of little importance to the e-mail user. Each e-mail message that the user receives requires time and effort to process and to prioritize. To save time, an e-mail user may read a high percentage of e-mail messages that originate from one person, such as a manager, while only reading a small percentage of e-mail messages that originate from another e-mail address, such as a company newsletter.

What is needed is a method to automatically prioritize e-mail messages in an e-mail client application so that the e-mail user does not have to waste time and effort searching through less important e-mail messages.

### SUMMARY

The invention provides methods and systems for prioritizing e-mail messages based on the status of existing e-mail messages.

An aspect of the present invention provides a method for prioritizing e-mail messages. This method includes the steps of presenting a list including a plurality of e-mail messages where each e-mail message includes a status indicating whether the e-mail message has been opened; assigning an index number to each e-mail sender where the index number includes the ratio of the total number of e-mail messages from an e-mail sender that includes a status of opened to the total number of e-mail messages received from the sender; and receiving a new e-mail message from an e-mail sender and placing the received e-mail message in the list of e-mail messages of an e-mail client application based on a revised index number for the e-mail sender, where the revised index number includes a recalculation of the index number based on a new total number of e-mail messages received from the e-mail sender of the new e-mail message.

### BRIEF DESCRIPTION OF THE DRAWINGS

FIG. 1 depicts an operating environment in accordance with certain exemplary embodiments.

FIG. 2 is a block diagram illustrating a general component architecture for a conventional computer constructed in accordance with certain exemplary embodiments.

FIGS. 3A and 3B depict e-mail client application user interfaces in accordance with certain exemplary embodiments.

FIG. 4 provides a flow diagram for prioritizing e-mail messages based on the status of existing e-mail messages in accordance with certain exemplary embodiments.

### DETAILED DESCRIPTION OF EXEMPLARY EMBODIMENTS

The present invention provides methods and systems for prioritizing e-mail messages based on the status of existing e-mail messages. Specifically, the invention provides methods and systems for prioritizing e-mail messages based on the number of e-mail messages from e-mail senders that have been opened versus the number of e-mail messages from e-mail senders that have not been opened.

Turning now to the drawings, in which like numerals indicate like elements throughout the figures, exemplary embodiments of the invention are described in detail.

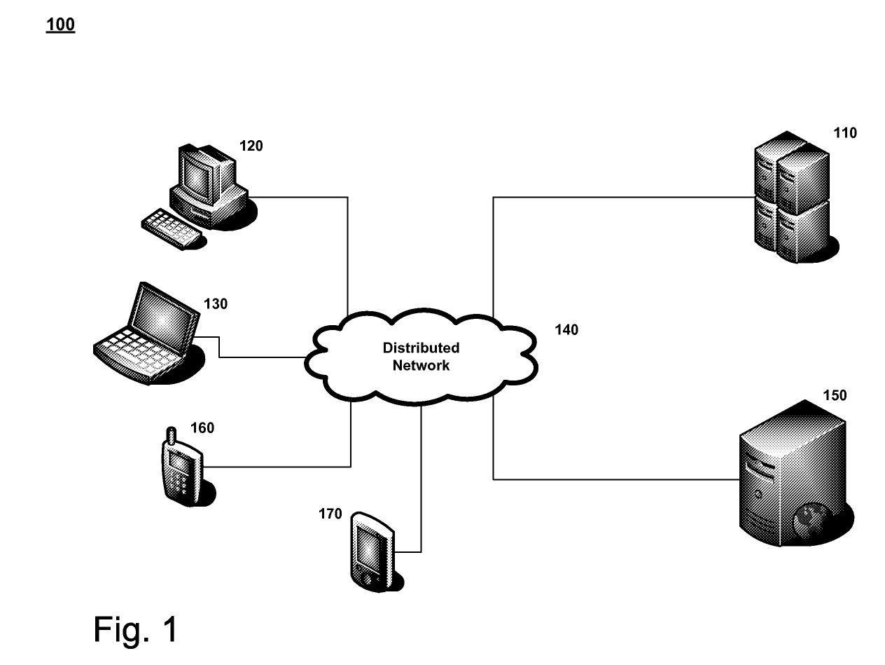

FIG. 1 depicts an operating environment 100 in accordance with certain exemplary embodiments. Referring to FIG. 1, an e-mail server 110 and a web server 150 are connected to a distributed network 140, such as the Internet. Connected to the e-mail server 110 and web server 150 through the distributed network 140 are client devices, such as a conventional computer 120, a laptop computer 130, a smart phone 160, and a personal digital assistant (PDA) 170. Of course, any number of client devices may be connected to the e-mail server 110 and web server 150 through the distributed network 140. These client devices may include other conventional computers (not shown) and other mobile communications devices (not shown). The distributed network 140 may be a local area network (LAN), private wide area network (WAN), or other network and is not restricted to the World Wide Web.

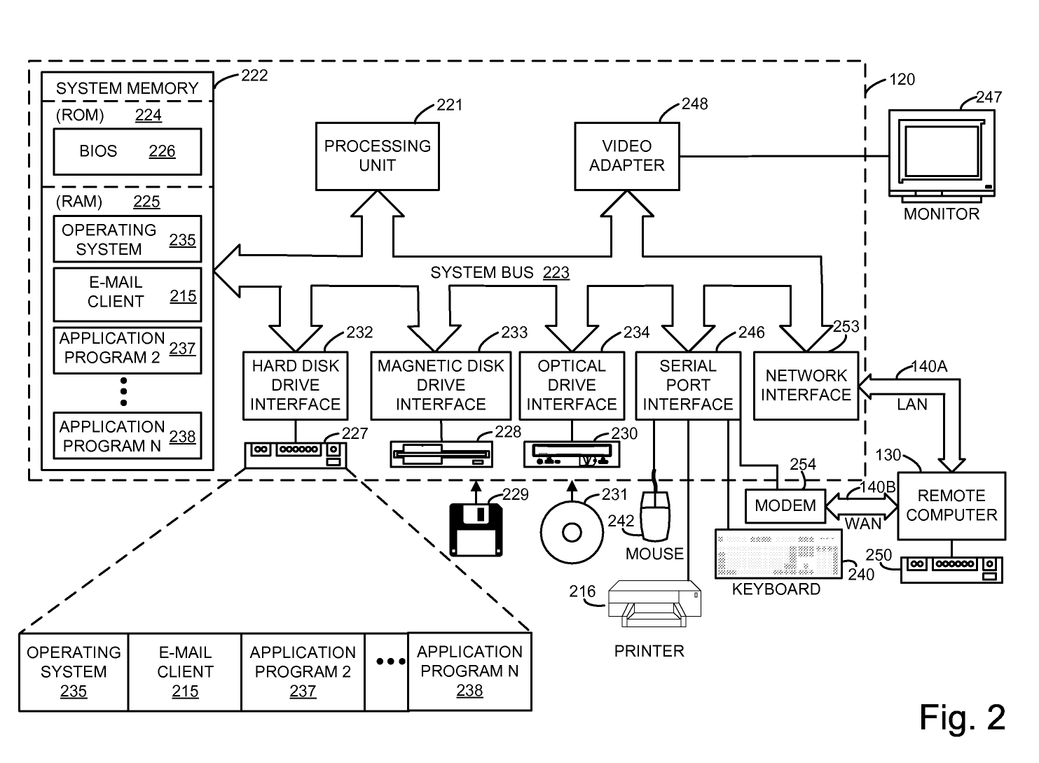

FIG. 2 is a block diagram illustrating a general component architecture for a conventional computer 120, in accordance with certain exemplary embodiments. Generally, the computer 120 includes a processing unit 221, a system memory 222, and a system bus 223 that couples system components, including the system memory 222, to the processing unit 221. The system bus 223 can include any of several types of bus structures, including a memory bus or memory controller, a peripheral bus, or a local bus, using any of a variety of bus architectures. The system memory 222 includes a read-only memory (“ROM”) 224 and a random access memory (“RAM”) 225. A basic input/output system (BIOS) 226 containing the basic routines that help to transfer information between elements within the computer 120, such as during start-up, is stored in the ROM 224.

The computer 120 also includes a hard disk drive 227 for reading from and writing to a hard disk (not shown), a magnetic disk drive 228 for reading from or writing to a removable magnetic disk 229 such as a floppy disk, and an optical disk drive 230 for reading from or writing to a removable optical disk 231 such as a CD-ROM, compact disk-read/write (CD/RW), DVD, or other optical media. The hard disk drive 227, magnetic disk drive 228, and optical disk drive 230 are connected to the system bus 223 by a hard disk drive interface 232, a magnetic disk drive interface 233, and an optical disk drive interface 234, respectively. Although the exemplary conventional computer 120 employs a ROM 224, a RAM 225, a hard disk drive 227, a removable magnetic disk 229, and a removable optical disk 231, other types of computer readable media also can be used in the exemplary conventional computer 120. For example, the computer readable media can include any apparatus that can contain, store, communicate, propagate, or transport data for use by or in connection with one or more components of the computer 120, including any electronic, magnetic, optical, electromagnetic, infrared, or semiconductor system (or apparatus or device) or propagation medium, such as magnetic cassettes, flash memory cards, digital video disks, Bernoulli cartridges, and the like. The drives and their associated computer readable media can provide nonvolatile storage of computer-executable instructions, data structures, program modules, and other data for the computer 120.

A number of modules can be stored on the ROM 224, RAM 225, hard disk drive 227, magnetic disk 229, or optical disk 231, including an operating system 235, an e-mail client application 215, and application modules 237-238. Application modules 237-238 can include routines, sub-routines, programs, objects, components, data structures, etc., which perform particular tasks or implement particular abstract data types. A user can read, send, and manage e-mail messages that reside on an e-mail server 110 using an e-mail client application 215.

A user can enter commands and information to the computer 120 through input devices, such as a keyboard 240 and a pointing device 242. The pointing device 242 can include a mouse, a trackball, an electronic pen that can be used in conjunction with an electronic tablet, or any other input device known to a person of ordinary skill in the art, such as a microphone, joystick, game pad, satellite dish, scanner, or the like. These and other input devices are often connected to the processing unit 221 through a serial port interface 246 that is coupled to the system bus 223, but can be connected by other interfaces, such as a parallel port, game port, a universal serial bus (USB), or the like. A display device 247, such as a monitor, also can be connected to system bus 223 by way of an interface, such as a video adapter 248. In addition to the display device 247, the computer 120 can include other peripheral output devices, such as speakers (not shown) and a printer 216.

The computer 120 is configured to operate in a networked environment using logical connections to one or more remote computers 130, e-mail servers 110, or web servers 150. While the remote computer 130 typically includes many of the elements described above relative to the computer 120, only a memory storage device 250 has been illustrated in FIG. 2 for simplicity. The logical connections depicted in FIG. 2 include a LAN 140A and a WAN 140B. Such networking environments are commonplace in offices, enterprise-wide computer networks, intranets, and the internet.

When used in a local area network “LAN” environment, the computer 120 is often connected to the “LAN” through a network interface or adapter 253. When used in a wide area network “WAN” environment, the computer 120 typically includes a modem 254 or other means for establishing communications over the “WAN”, such as the Internet. The modem 254, which can be internal or external, is connected to system bus 223 by means of a serial port interface 246.

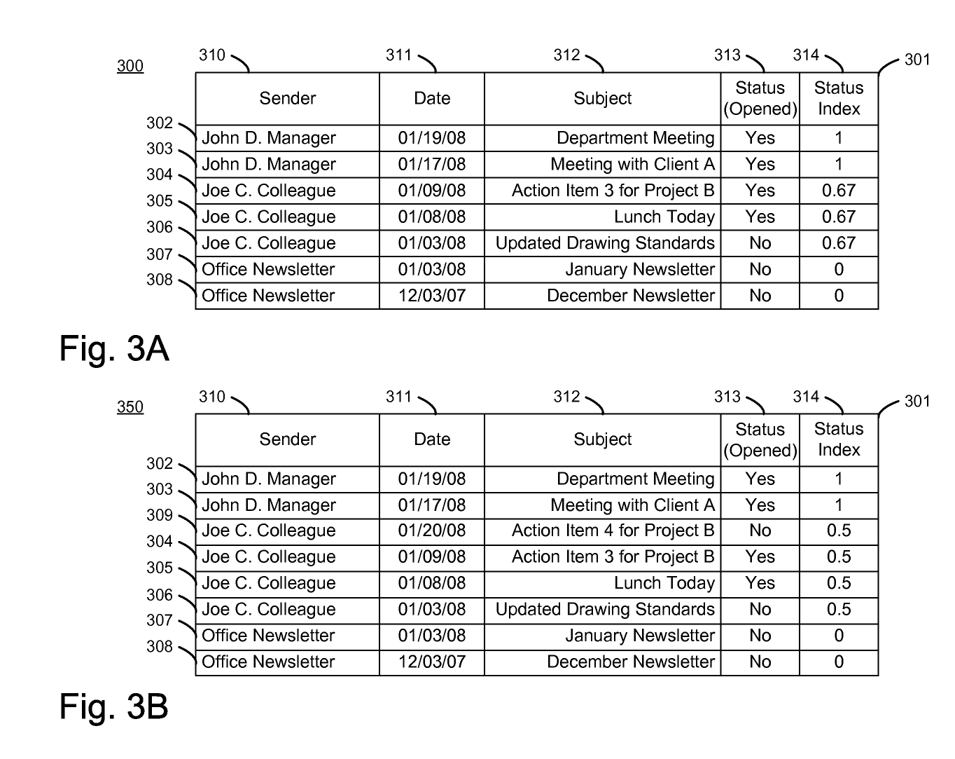

FIGS. 3A and 3B depict e-mail client application user interfaces 300 and 350 in accordance with certain exemplary embodiments. Referring to FIGS. 1, 2, 3A and 3B, e-mail users can read, send, and manage e-mail messages 302-309 that are stored on an e-mail server 110 by using an e-mail client application 215. An e-mail client application may contain folders to organize e-mail messages, such as an inbox 301 where new messages may be displayed. An inbox 301 may display many attributes of e-mail messages 302-309, such as the name of the sender 310, the date 311 the e-mail message was received, the subject 312 of the e-mail message, the status 313 of the e-mail message, the status index 314 of the e-mail sender, message urgency (not shown), and part of the e-mail message (not shown).

In one exemplary embodiment, the status 313 of an e-mail message 302-309 provides whether an e-mail message has been opened by the e-mail user. The status index 314 of an e-mail message is based on the sender of the message and, more specifically, on the number of e-mail messages from that e-mail sender that an e-mail user has opened versus the number of e-mail messages from that e-mail sender that the e-mail user has not opened. In one exemplary embodiment, the status index 314 is calculated by dividing the number of opened messages from an e-mail sender by the total number of messages from that e-mail sender in the e-mail receiver's inbox 301, or received over a specified period of time. For example, referring to FIG. 3A, the e-mail message inbox 301 displays two received e-mail messages 302-303 from e-mail sender “John D. Manager,” three e-mail messages 304-306 from e-mail sender “Joe C. Colleague,” and two e-mail messages 307-308 from e-mail sender “Office Newsletter.” Both e-mail messages 302-303 from e-mail sender John D. Manager have been opened. The status index 314 for these messages from e-mail sender John D. Manager is calculated by dividing two (the number of opened e-mail messages 302-303 from John D. Manager) by two (the total number of e-mail messages 302-303 from John D. Manager), giving a status index 314 of 1 for these messages. Two of the three e-mail messages 304-306 from e-mail sender Joe C. Colleague have been opened. The status index 314 for these messages from e-mail sender Joe C. Colleague is calculated by dividing two (the number of opened e-mail messages 304-305 from Joe C. Colleague) by three (the total number of e-mail messages 304-306 from Joe C. Colleague), giving a status index 314 of 0.67 for these messages.

In one exemplary embodiment of the present invention, e-mail users may order the e-mail messages in the e-mail message inbox 301 based on a priority. For example, a user could order the e-mail messages by the date 311, by e-mail sender 310, or by status index 314. The e-mail user may order the e-mails with highest priority e-mail messages displayed first or with lowest priority e-mail messages displayed first. For example, FIG. 3A shows the e-mail messages 302-308 ordered by status index 314.

E-mail users may also order messages using multiple prioritization mechanisms. For example, the status index 314 may be the primary prioritization mechanism and the date received 311 may be a secondary prioritization mechanism. In this case, the e-mail messages will first be grouped by status index 314. Then, the e-mail messages in each group will be ordered by date 311. Alternatively, if the date received 311 is the primary prioritization mechanism and the status index 314 is the secondary prioritization mechanism, the e-mail messages will first be grouped by date 311. Then, the e-mail messages in each group will be ordered by status index number 314.

Referring to FIGS. 1, 3A and 3B in which the messages are ordered with highest priority e-mail messages displayed first based on status index 314; when a new e-mail message 309 is received by the e-mail server 110 addressed to the e-mail user, the new e-mail message 309 is placed in the e-mail message inbox 301 based on the status index 314 for messages from the sender 310 of the new e-mail message 309. In one exemplary embodiment of the present invention, the status index 314 for messages from each e-mail sender 310 is calculated immediately after an e-mail user receives a new message 309. In another exemplary embodiment, the status index 314 may be calculated at specified time intervals. For example, the status index 314 for messages from e-mail sender Joe C. Colleague is recalculated when new e-mail message 309 from Joe C. Colleague is received. The new status index for messages from Joe C. Colleague is calculated by dividing two (the number of opened e-mail messages 304-305 from Joe C. Colleague) by four (the total number of e-mail messages 304-306, 309 from Joe C. Colleague), giving a status index of 0.5 for these messages. Because the status index for messages from Joe C. Colleague (0.5) is greater than the status index 314 for messages from e-mail sender Office Newsletter (0) but below the status index 314 for messages from e-mail sender John D. Manager (1), the new e-mail message 309 is placed below the e-mail messages 302-303 from e-mail sender John D. Manager and above the e-mail messages 307-308 from e-mail sender Office Newsletter.

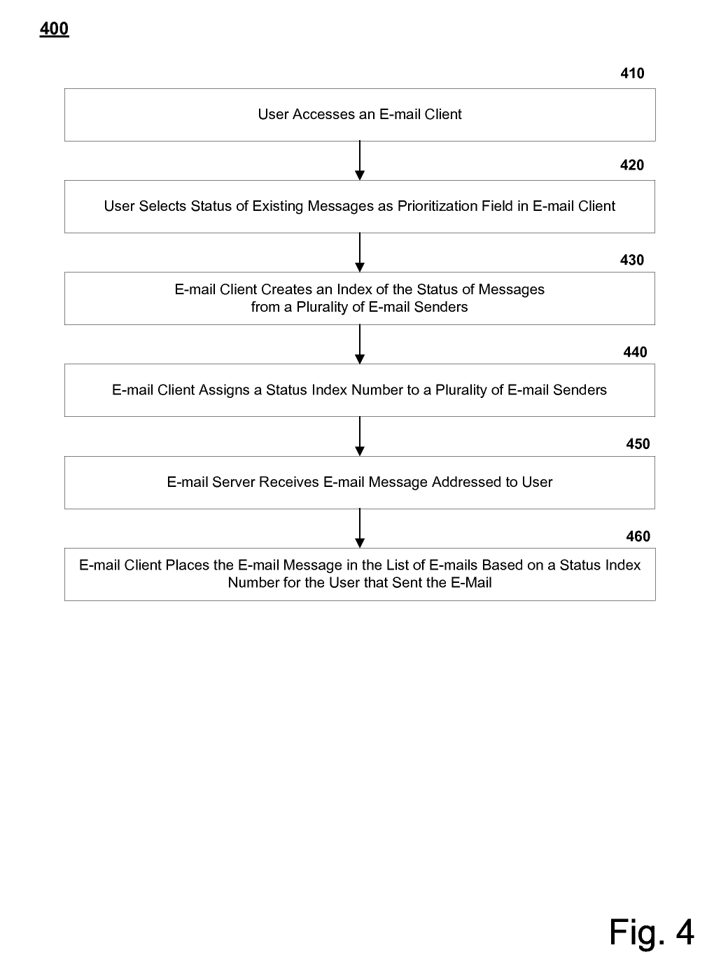

FIG. 4 provides a flow diagram 400 for prioritizing e-mail messages based on the status of existing e-mail messages in accordance with certain exemplary embodiments. Referring to FIGS. 1, 2, 3A, 3B, and 4 at step 410, a user may utilize a conventional computer 120 to access an e-mail client application 215.

At step 420, a user selects a “Status Index” prioritization field 314 in an e-mail client application 215. In one exemplary embodiment of the present invention, the user may use a pointing device such as a mouse 242 to “click” on a column header reading “Status Index.”

At step 430, the e-mail client application 215 searches existing e-mail messages 302-308 and creates an index of the status 313 of messages from each e-mail sender 310 that an e-mail message 302-308 was received from. In one exemplary embodiment of the present invention, a default search parameter may be provided. For example, a parameter limiting the search to e-mail messages received in the last three months may be used by the e-mail client application 215.

At step 440, the e-mail client application 215 assigns a status index number 314 to each e-mail sender 310 that an e-mail message 302-308 was received from. The status index number 314 is based on the number of e-mail messages from that e-mail sender that have been received and opened versus the number of e-mail messages from that e-mail sender that have been received but not opened.

At step 450, a new e-mail message 309 is received at the e-mail server 110 addressed to the e-mail user.

At step 460, the e-mail client application 215 re-calculates the status index of the e-mail sender that sent the new e-mail. The e-mail client application 215 then places the new e-mail message 309 into the list of e-mail messages 302-309 in the e-mail message inbox 301 based on the status index 314 for the e-mail sender that sent the new e-mail message 309.

One of ordinary skill in the art would appreciate that the present invention provides methods and systems for prioritizing e-mail messages based on the status of existing e-mail messages. Specifically, the invention provides methods and systems for prioritizing e-mail messages based on the number of e-mail messages from e-mail senders that have been opened versus the number of e-mail messages from e-mail senders that have not been opened.

What is claimed is:

1. A method for prioritizing e-mail messages, comprising the steps of:
presenting a list comprising a plurality of e-mail messages wherein each e-mail message comprises a status indicating whether the e-mail message has been opened;
assigning an index number to each of a plurality of e-mail senders wherein the index number comprises the ratio of the total number of e-mail messages from an e-mail sender that comprises a status of opened to the total number of e-mail messages received from the sender; and
receiving a new e-mail message from one of the plurality of e-mail senders and placing the received e-mail message in the list of e-mail messages of an e-mail client application based on a revised index number for the e-mail sender, wherein the revised index number comprises a recalculation of the index number based on a new total number of e-mail messages received from the e-mail sender of the new e-mail message.
